(19) United States
(12) Patent Application Publication
(10) Pub. No.: US 2025/0310073 A1
(43) Pub. Date: Oct. 2, 2025

(54) DYNAMIC TIME DIVISION DUPLEX CONFIGURATION POWERED BY ARTIFICIAL INTELLIGENCE / MACHINE LEARNING

(71) Applicant: AT&T Intellectual Property I, L.P., Atlanta, GA (US)

(72) Inventors: Jianchun Zhou, Bellevue, WA (US); Yakun Gao, Suwanee, GA (US)

(73) Assignee: AT&T Intellectual Property I, L.P., Atlanta, GA (US)

(21) Appl. No.: 18/624,507

(22) Filed: Apr. 2, 2024

(51) Int. Cl. H04L 5/14; H04W 72/0446; H04W 72/54

(52) U.S. Cl. CPC H04L 5/14; H04W 72/0446; H04W 72/54

(57) ABSTRACT

Aspects of the subject disclosure may include, for example, receiving a registration from a user equipment (UE) accessing a radio communication network, selecting an initial time division duplex (TDD) configuration for the UE, communicating information about the initial TDD configuration to the UE, communicating with the UE according to the initial TDD configuration, detecting a changed condition for the UE, selecting a new TDD configuration for the UE, wherein the new TDD configuration is based on the changed condition for the UE, and communicating the new TDD configuration to the UE for further communication with the radio communication network. Other embodiments are disclosed.

### FIELD OF THE DISCLOSURE

This disclosure relates to dynamic configuration of time division duplex communication in a mobile radio system.

### BACKGROUND

Current and future mobile radio systems such as cellular radio networks support use of time division duplex (TDD) communication between a network element such as a base station and a mobile radio. In TDD communication, a single radio carrier is used but is divided into time slots that can be allocated either to the downlink (DL) or the uplink (UL). Some slots and symbols are treated as “flexible” and are initially unallocated but can be allocated to either the uplink or the downlink. The downlink refers to the radio channel from the base station or other network element to the mobile radio. The uplink refers to the radio channel from the mobile radio to the base station or other network element.

Specifications published for the fifth generation (5G) mobile communication system provide fixed combinations of downlink time slots and uplink time slots and to select a particular combination based on current usage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of depicts an illustrative embodiment of a radio communication network functioning within the communication network of FIG. 1 in accordance with various aspects described herein.

FIG. 2B illustrates a table showing an embodiment of available slot format configurations in an exemplary next-generation radio communication network.

FIG. 2C depicts an illustrative embodiment of operational guidelines for an artificial intelligence and machine learning model for controlling dynamic time division duplex patterns and slot formats in a mobile radio communication system in accordance with various aspects described herein.

FIG. 2D depicts an illustrative embodiment of a method in accordance with various aspects described herein.

FIG. 2E depicts an illustrative embodiment of an artificial intelligence or machine learning method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for training an artificial intelligence/machine learning model the best combination of TDD pattern and slot format, in real time, and to dynamically modify those in a network to respond to changes in application behavior and radio conditions. Other embodiments are described in the subject disclosure.

One or more aspects of the subject disclosure include receiving a registration from a user equipment (UE) accessing a radio communication network, selecting an initial time division duplex (TDD) configuration for the UE, communicating information about the initial TDD configuration to the UE, and communicating with the UE according to the initial TDD configuration. Aspects further include detecting a changed condition for the UE, selecting a new TDD configuration for the UE, wherein the new TDD configuration is based on the changed condition for the UE, and communicating the new TDD configuration to the UE for further communication with the radio communication network.

One or more aspects of the subject disclosure include selecting a TDD configuration for a UE in a radio access network, providing information about the TDD configuration to the UE, communicating with the UE according to the TDD configuration, selecting, by an artificial intelligence/machine learning (AI/ML) model, a new TDD configuration for the UE, wherein the AI/ML model selects the new TDD configuration based on a changed condition for the UE in the radio access network, the new TDD configuration to provide improved throughput or reduced delay for the UE, or both, and providing, to the UE, information about the new TDD configuration.

One or more aspects of the subject disclosure include assigning an initial TDD configuration to a UE for communication with a radio access network, communicating with the UE according to the initial TDD configuration, detecting a change in the communicating with the UE, and assigning a new TDD configuration to the UE, wherein the assigning comprises selecting the new TDD configuration based on changes in communication patterns of the UE with the radio access network, the new TDD configuration selected to improve data throughput between the UE and the radio access network. Aspects further include communicating, by the processing system, with the UE according to the new TDD configuration.

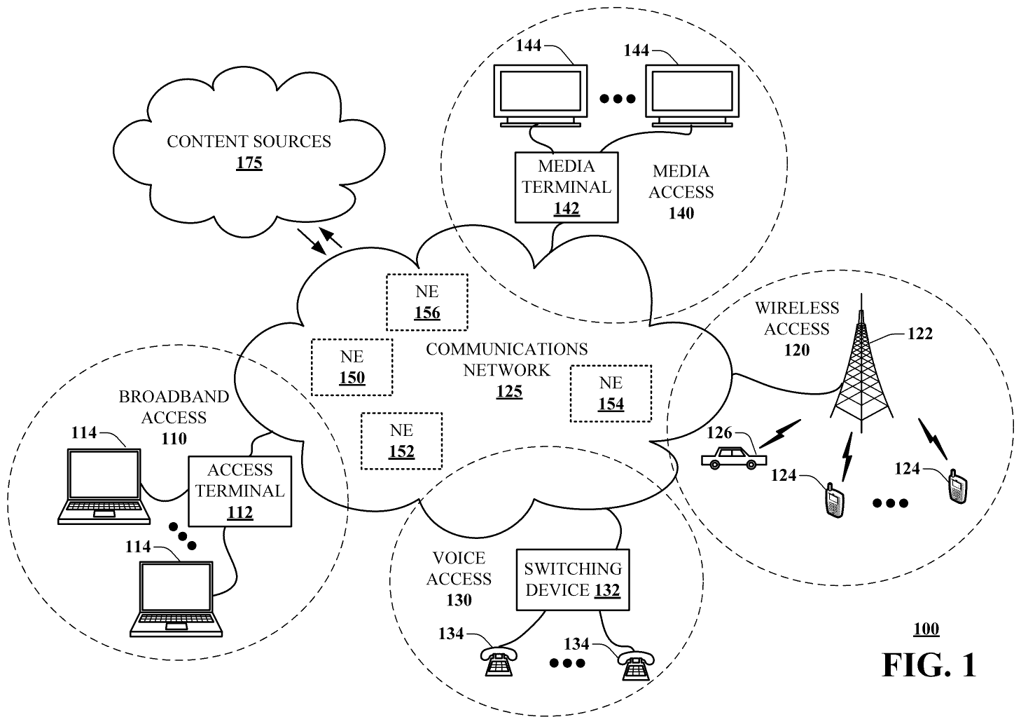

Referring now to FIG. 1, a block diagram is shown illustrating an example, non-limiting embodiment of a system 100 in accordance with various aspects described herein. For example, system 100 can facilitate in whole or in part selecting an initial time division duplex (TDD) configuration for a user device in a radio network and dynamically modifying the TDD configuration based on conditions for the user device and using an artificial intelligence model or machine learning model. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

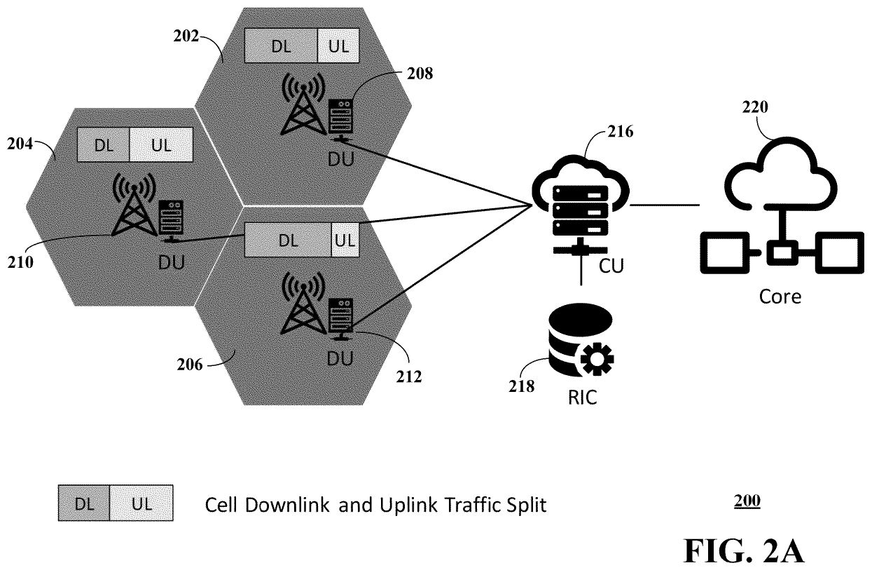

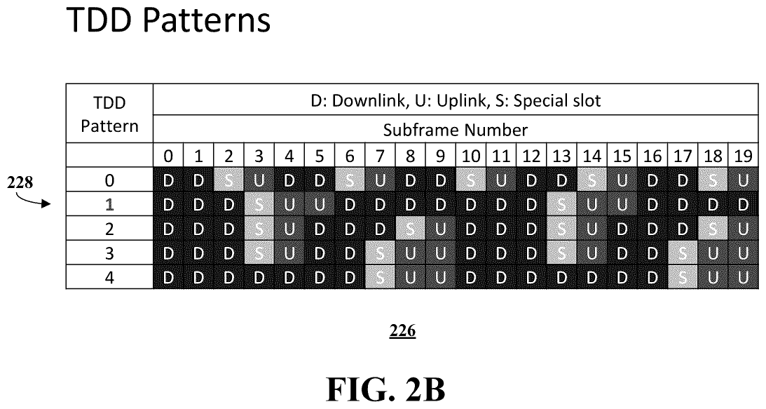

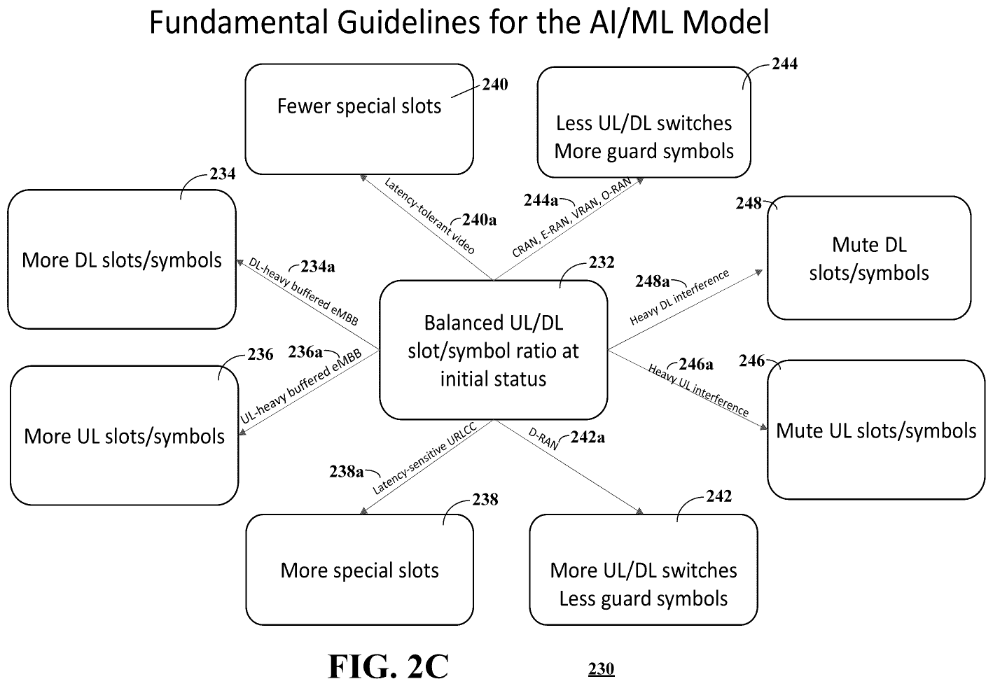

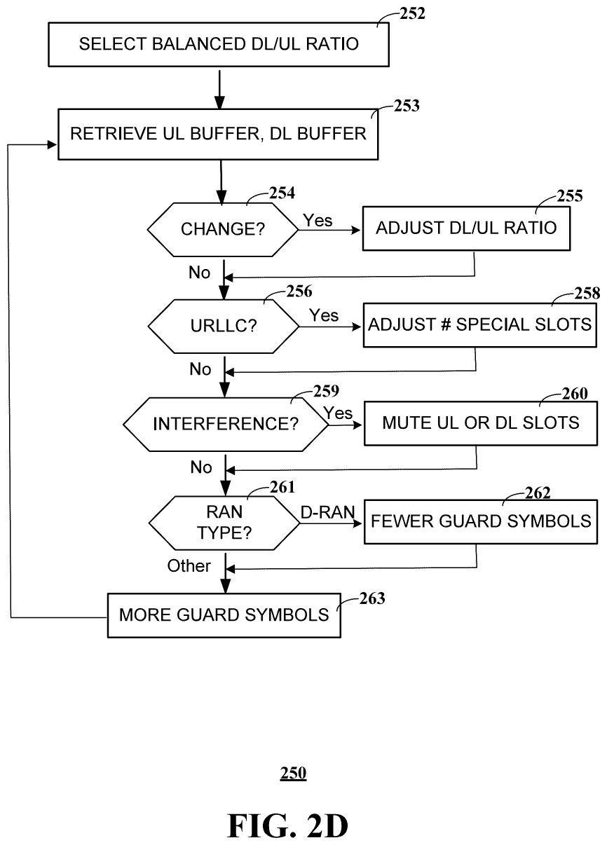

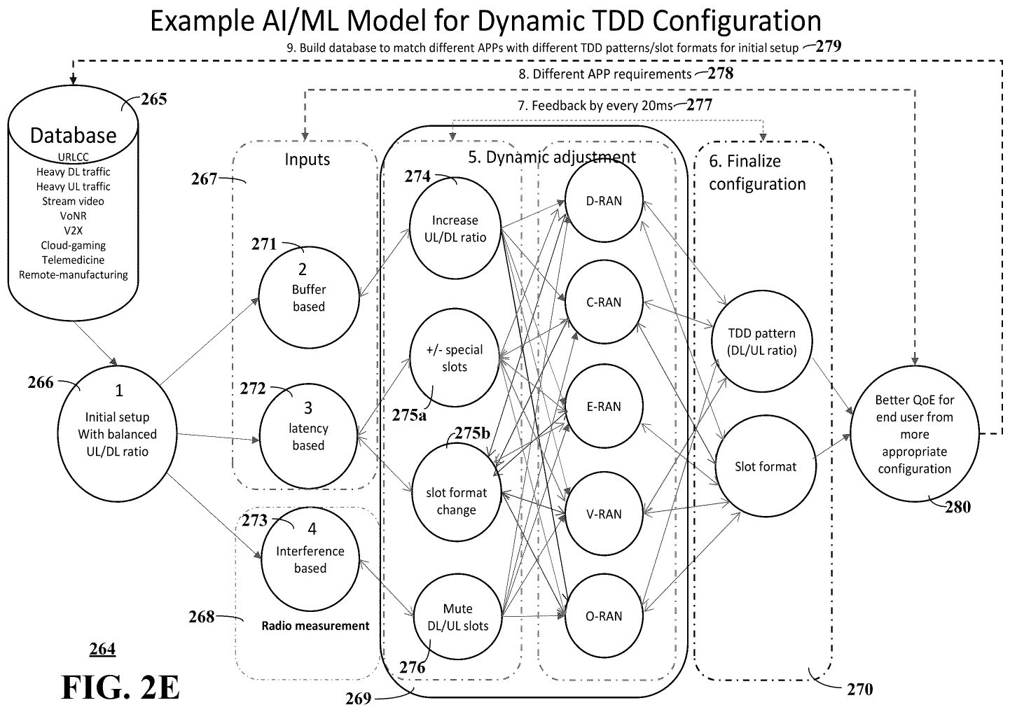

FIG. 2A is a block diagram illustrating an example, non-limiting embodiment of a radio communication network 200 functioning within the communication network 125 of FIG. 1 in accordance with various aspects described herein. The radio communication network 200 may be an exemplary embodiment of a mobile radio communication system providing radio communication between network elements and one or more mobile radios. The mobile radios may be referred to as user equipment or UEs. The radio communication network may be, for example, a fifth generation (5G), sixth generation (6G) or other radio communication system and may operate according to a published standard such as the standards published by the 3^{rd} Generation Partnership Project (3GPP) standards organization. 3GPP® is a registered trademark of the 3^{rd} Generation Partnership Project.

The radio communication network 200 in the exemplary embodiment of FIG. 2A includes three cells including a first cell 202, a second cell 204 and a third cell 206. The first cell 202 is served by a first distributed unit (DU) 208. The second cell 204 is served by a second distributed unit (DU) 210. The third cell 206 is served by a third distributed unit (DU) 212. The radio communication network 200 further includes a centralized unit (CU) 216 and a radio access network (RAN) intelligent controller (RIC) 218. The CU 216 is in data communication with the core 5G network 220.

The radio communication network 200 implements a RAN using radio access technology. In the illustrated example, Third Generation Partnership Project (3GPP) new radio (NR) 5G cellular network technology is implemented in the radio communication network 200. However, any suitable radio access technology now known or later developed may be selected. As noted, the radio communication network 200 may include any suitable number of cells and it is anticipated that the radio communication network 200 will include a large number of cells, such as 100 cells served by 100 respective DUs.

The DUs 208, 210, 212 are logical nodes that perform a subset of eNodeB functions. Each respective DU provides mobile radio communication service to user equipment (UE) devices located in the respective cell served by the DU. In the example of FIG. 2B, each respective DU, including DU 208, DU 210, and DU 212 is one DU of a cluster of DUs serving respective geographically contiguous areas defined by the respective cells 202, 204, 206.

Each DU including first DU 208, second DU 210 and third DU 212 is in communication with the CU 216. In some embodiments, each respective DU is a remote radio head (RRH) or remote radio unit (RRU), providing radio frequency (RF) communication with UE in each respective cell. Each DU, including first DU 208, second DU 210 and third DU 212, may communicate with the CU 216 using fiber optic cable or other means of data communication.

The CU 216 provides control of the respective DUs in the radio communication network 200. The CU 216 is a logical node that performs a subset of eNodeB functions. Such functions may include transfer of user data, mobility control, radio access network sharing, positioning, session management, for example. The CU 216 provides baseband central control. The CU 216 generally controls the respective DUs. The split of functionality between the CU 216 and DUs such as DU 208, DU 210, and DU 212, is established by the network operator.

The CU 216 operates in conjunction with the RIC 218. The RIC 218 is a network element that controls certain aspects of the radio communication network 200. The RIC 218 provides access to some functions of the radio communication network 200. The RIC 218 may control operation of the CU 216 and respective DUs in the radio communication network 200.

In some embodiments, the RIC 218 operates in near-real time fashion and in non-real time fashion. Generally, non-real time operation occurs in a time frame greater than one second. Near-real time operation occurs in a time frame of less than one second. Non-real time functions include service and policy management, RAN analytics, and others. Near-real time functions may include load-balancing, interference detection and mitigation, quality of service management and handover control. In some applications, the RIC may receive information from a DU or a CU in near-real time, such as 50-100 ms. Such information may include how many UE are connected to a DU, information about UE throughput or cell throughput, etc. For example, a DU may make a determination of its current uplink to downlink traffic ratio and communicate information about that ratio to the CU for reception by the DU, all within 50-100 ms. All such information about network usage and conditions can be passed from the respective DU or CU 216 to the RIC 218.

Because of this near-real time operation, the RIC 218 can collect and act on rapidly changing network conditions. For example, in the case of a holiday or a particular event, the mix of uplink and downlink traffic can change, and can change very rapidly. The RIC 218, with near-real time access to information, can manage the radio communication network 200 including the CU 216 and DUs such as DU 208, DU 210 and DU 212 to respond to the changing conditions. In one particular example, the RIC 218 can respond to changing traffic conditions in the communication network 200 by changing the subframe configuration of respective DUs.

5G networks support time division duplex (TDD) mode in many frequency bands. Examples include frequency bands designated n34 to n53 and n77 to n79. Such bands may accommodate TDD mode with large bandwidth (up to 900 MHz for n77 to n79). In TDD mode, only one carrier is used which is divided into time slots that can be allocated either to the downlink (DL) or uplink (UL). In addition, some symbols and slots remain unallocated and are treated as “flexible” and can be subsequently allocated to either the uplink or the downlink according to system requirements. A major advantage of TDD relative to frequency division duplex (FDD) communication is that the TDD channel is considered to be reciprocal, thereby allowing improved implementation of channel estimation and link adaptation mechanisms such as precoding. This can be especially important for beamforming and the reuse of radio resources such as spectrum via spatial multiplexing.

In theory, a system operating in TDD mode can dynamically allocate time slots based on the need of applications and the quality of service offered without changing the carrier bandwidth. The current 3GPP specifications define many TDD slot pattern and slot formats configurations. FIG. 2B illustrates a table 226 showing some available slot format configurations in an exemplary next-generation radio communication network. In particular, table 226 shows slot format configurations for a 5G new radio (NR) communication system. Table 226 shows slot allocations at a frame level, where each frame of 20 subframes has a 10 ms duration. Table 226 illustrates several TDD patterns supporting different downlink and uplink slot allocation ratios. In addition to the downlink (D) and uplink (U) values, each subframe may also have a special value (S) where the content and purpose of the special subframe is defined by the 3GPP standard. For example, some network operators currently make use of TDD pattern number 1, indicated as pattern 228 in table 226 in FIG. 2B, with a slot ratio of 4DL:1UL, or four downlink time slots for every one uplink time slot, for frequency band n77. This assumes that two S subframes will be uses as D. This choice may be made under the assumption that end users use more downlink than uplink traffic. If the end user's application sends more UL traffic, the network operator may need to change the configuration to 1DL:4UL or similar. However, the network operator has not been able to change the configuration dynamically based on the behavior of an end user's application. The 3GPP standards which control time slot assignments are limited to a few pre-defined uplink/downlink combinations.

Furthermore, one 3GPP specification defines 56 different TDD slot formats for the case of normal cyclic prefix (CP). Each different TDD slot format has a different number of downlink (D), uplink (U) or flexible (F) orthogonal frequency division multiplexed (OFDM) symbols. This is set out, for example, in the standard 3GPP 38.213 V15.7m Table 11.1.1-1. Flexible or F slots can be downlink, uplink or a guard period required for a switch between uplink and downlink, for example, as radios require a finite amount of time to power up a transmitter circuit or a receiver circuit. Different RAN deployments have different synchronization accuracy and delay between the DU or remote radio head (RRH) and the CU or baseband unit (BBU) and require a different number of guard symbols during the switch. For example, a distributed RAN (DRAN) has less delay between RRH and BBU while a virtual RAN (V-RAN) has more delay between RRH and the BBU in the cloud.

In accordance with embodiments described herein, the network operator can dynamically select a particular TDD configuration and slot format according to a particular situation experienced by a UE. The situation may require a greater proportion of uplink slots or symbols, or a greater proportion of downlink slots or symbols at a particular time. The requirement may be due to particular activity of a UE or the user of the UE at the moment. For example, a user downloading a large file such as a video file will receive an improved experience if the uplink/downlink mix is shifted toward more downlinks to deliver the data of the file faster. Similarly, a user making use of the ultra-reliable low latency capability (URLLC) of 5G NR may prefer more downlink slots to improve download speeds or more uplink slots to improve upload speeds and reduce latency. The Enhanced Mobile Broadband (eMBB) service of 5G may be a UL-heavy service for selection of a particular TDD configuration.

By changing the TDD pattern and/or the slot format, the network operator can meet the diverse need of different applications and provide the best possible user experience. Unfortunately, the TDD patterns and slot formats defined in 3GPP specifications are relatively static in nature and cannot adapt to different applications in real time. In addition, the static configurations generate large interference when operators sharing a cell tower configure with different TDD patterns or slot formats in the same slot and transmit at the same time. For example, if one network operator configures a cell for uplink and another operators configures a collocated cell for downlink, interference may result. Instead, a fully dynamic TDD configuration powered by AI/ML is developed to meet diverse application requirements in real time which significantly improves TDD spectrum efficiency.

In some embodiments, reconfiguration of the communication network may include changing subframe configuration in the radio communication network 200. This can be done under control of the RIC 218 or other components.

A device in TDD mode operates on allocated time slots and requires stringent phase and time synchronization to avoid interference between uplink and downlink transmissions. Among network operators, RAN deployment is evolving from D-RAN to C-RAN, V-RAN and O-RAN. Each generation of evolution renders synchronization more challenging. For example, the different amounts of delay between RRH and BBU for the different RAN types requires different TDD patterns or slot formats or both to reduce number of switches between uplink and downlink as much as possible. Further, the different amounts of delay require different guard times, expressed as a number of symbols, between the uplink and the downlink in special slots to reduce high block error rate (BLER) during the switch. BLER corresponds to a ratio of the number of erroneously received code blocks to the total number of received code blocks.

Further, different TDD patterns are designed for different purposes. For example, pattern #0 according to standard 3GPP 38.213 V15.7m Table 11.1.1-1 is for evenly split traffic between uplink and downlink, and pattern #1 is designed to carry more downlink traffic than uplink. Still further, different slot formats are also designed for different purposes such as providing more downlink or uplink throughput, or to provide fast ACK/NACK feedback, or different amounts of guard time during switch from a radio's transmit mode to receive mode. The rather static TDD patterns or slot formats defined by 3GPP standards so far cannot solve these problems.

In a further example, in many applications, RRH radio units of different network operators are collocated on common structures such as radio towers. Moreover, the operators used common or adjacent spectrum, such as N77 at 3300 to 4200 MHz. The collocation and the frequency assignments for the different operators may create an interference situation between the two operators and UEs operating in their respective networks. If the TDD pattern or slot format used by both network operators for their RRHs is not the same, a first type of interference may occur in the time slot when it is allocated for uplink by one operator but for downlink by another operator. Further, a second type of interference may result if the one operator and the other operator both transmit on the same downlink time slot and their respective UEs transmit on the same uplink time slot. However, letting both operators have full freedom to dynamically change the TDD pattern and slot format, the second type of interference can be easily avoided. Also, requiring a radio to mute temporarily when interference is detected can limit or eliminate the first type of interference.

Accordingly, a system and method in accordance with various aspects described herein enables dynamic TDD pattern and slot format configuration by a network operator. The operator may choose any suitable TDD pattern and slot format configuration for particular conditions such as traffic conditions.

Due to the complexity of TDD patterns and slot formats required in real time environment, it is challenging to configure one or more static configurations to satisfy the diverse needs from all applications. The 55 slot formats defined by 3GPP standards are not sufficient. Fortunately, artificial intelligence and machine learning (AI/ML) have recently progressed to the point that it is possible to train an AI/ML model to identify the best combination of TDD pattern and slot format in real time and change it in the network dynamically to handle the changes in application behavior and radio condition.

The AI/ML model may incorporate any suitable artificial intelligence or machine learning processes, or combinations of these. In some examples, the AI/ML model may be a supervised ML model and may be trained with any suitable data, such as historical network usage data. The AI/ML model may be located at any suitable location such as the RIC 218 of FIG. 2A, or a combination of locations including virtual locations on the cloud or edge nodes. Generally, the AI/ML model should be able to respond in near real time to changing conditions in the network to select particular TDD patterns and slot formats in portions of the radio network 200.

FIG. 2C depicts an illustrative embodiment of operational guidelines 230 for an artificial intelligence and machine learning model for controlling dynamic TDD patterns and slot formats in a mobile radio communication system in accordance with various aspects described herein. The operational guidelines are comparable to a state diagram for the AI/ML model to implement. The TDD pattern and slot format may be selected by the AI/ML model according to each state, defined by the several boxes in the drawing figure. Each state defines an operational condition or goal for the AI/ML model to select, based on a current operating condition in the radio network. The selected TDD pattern and slot format may be as localized or as wide-ranging as required, according to the AI/ML model. For example, the AI/ML model may select a particular TDD pattern and slot format for a particular RRH serving a particular cell or sector or even a particular UE. At the other extreme, the AI/ML model may select a particular TDD pattern and slot format for a broad region of the mobile network. Further, the selected TDD pattern and slot format may be updated dynamically, in near real time, as required by changing conditions in the network.

In the illustrated example, the center point or starting point or default condition for the TDD pattern and slot format is a balanced uplink/downlink (UL/DL) ratio, state 232. This balanced UL/DL ratio in the example applies to both TDD slot ratio and the symbol ratio within a subframe. For example, initially, when a data session is set up for a UE, the AI/ML model has little or no awareness of network activity including what applications users may be running on particular UEs, as well as the traffic requirements of those UEs and applications. The balanced UL/DL ratio in the example is 1 UL:1 DL. However, other numbers of dedicated uplink slots or symbols could be used, such as 4 consecutive UL slots followed by 4 consecutive DL slots.

In embodiments, the downlink communication uses a downlink buffer to store data for transmission on the downlink to the UE from the RRH or other network equipment. Similarly, the UE maintains an uplink buffer to store data for transmission on the uplink from the UE to the RRH or other network equipment. The UE routinely reports to the network the size of the uplink buffer or the amount of data stored in the buffer to be transmitted. For example, during times of heavy usage, when the UE has substantial data to upload, the UE buffer may be consistently full or nearly full of data. Similarly, the network tracks and reports that size of the downlink buffer, or the amount of data in the downlink buffer awaiting transmission to a UE. Information about the size of the downlink buffer and the size of the uplink buffer may be reported to the AI/ML model.

In a first condition, the AI/ML model may detect a relatively full downlink buffer and select a TDD slot ratio and the symbol ratio providing relatively more downlink slots or symbols, state 234. This may be indicated by the AI/ML model detecting a downlink heavy application such as the 5G NR enhanced mobile broadband (eMBB) service, step 234a. This service is an example of a situation or application where the network has a large amount of data to transmit to the UE. To accommodate the data, the AI/ML model selects state 234 and selects a TDD slot ratio and a symbol ratio providing relatively more downlink communication capacity. For example, the balanced state 232 may include a one-to-one DL to UL ratio. The state 234 may include an eight-to-one ratio of downlink slots to uplink slots or symbols. Information about the selected TDD slot ratio and the selected symbol ratio may be communicated to network equipment and the UE in any suitable manner.

In a second condition, the AI/ML model may detect a relatively full uplink buffer and select a TDD slot ratio and the symbol ratio providing relatively more uplink slots or symbols, state 236. This may be indicated by the AI/ML model detecting a uplink heavy application such as the eMBB service requested by the UE, step 236a. To accommodate the data, the AI/ML model selects state 236 and selects a TDD slot ratio and a symbol ratio providing relatively more uplink communication capacity. Information about the selected TDD slot ratio and the selected symbol ratio may be communicated to network equipment and the UE in any suitable manner.

In a third condition, the AI/ML model may detect a need to use relatively more special slots or flexible symbols, state 238. This may occur, for example if the UE device initiates a service or application requiring the 5G NR ultra-reliable low latency communication (URLLC) service, step 238a. An example of such a service is vehicle to vehicle communications in which a UE associated with a first vehicle communicates with a UE associated with another nearby vehicle. Such communications must be completed accurately and with minimal latency through the network. Information about the selected TDD slot ratio and the selected symbol ratio may be communicated to network equipment and the UE in any suitable manner.

In a fourth condition, the AI/ML model may detect that the UE can use relatively fewer special slots or flexible symbols, based on the activity of the UE, state 240. In the example, a latency-tolerant video is to be communicated from the network to the UE, step 240a. Information about the selected TDD slot ratio and the selected symbol ratio be communicated to network equipment and the UE in any suitable manner.

In a fifth condition, the AI/ML model may detect that the UE would operate more efficiently using relatively more uplink and downlink symbols and fewer guard symbols, state 242. For example, the AI/ML model may determine that the radio access network being employed is a D-RAN, step 232a, and may adjust the number of guard symbols used accordingly. In a D-RAN, because the delay from BBU to RRH is relatively small and constant, less accommodation by way of added guard symbols is required. Information about the selected TDD slot ratio and the selected symbol ratio may be communicated to network equipment and the UE in any suitable manner.

In a sixth condition, the AI/ML model may detect that the UE would operate more efficiently using relatively fewer uplink and downlink switches and more guard symbols, state 244. For example, the AI/ML model may determine that the radio access network being employed is one of a cloud radio access network or centralized radio access network (C-RAN), a virtual radio access network (V-RAN) or an open radio access network (O-RAN), step 244a. Generally, one difference between these different RAN types is the distance between the BBU and the RRH. In a D-RAN, the BBU and the RRH may be collocated or located very close together. In the other networks, the BBU may be distant from the RRH, as much as several miles, implying a time delay of up to 100 ms. This is equivalent to 14 symbols for 35 μs per symbol. The increased delay must be accommodated. For example, the AI/ML model may choose to insert three or more flexible (F) symbols between an uplink frame and a downlink frame. The AI/ML model may adjust the number of guard symbols used accordingly. Information about the selected TDD slot ratio and the selected symbol ratio may be communicated to network equipment and the UE in any suitable manner.

In a seventh condition, the AI/ML model may detect that the UE is experiencing heavy uplink interference, step 246a. Interference may be detected in any suitable manner, such as an increase in signal to noise ratio (SNR) or block error rate (BLER) reported by the UE or other network radio. Information about radio characteristics, the radio channel and radio operation is routinely reported to the network and provided to the AI/ML model. Accordingly, the AI/ML model will instruct the UE or other network equipment to temporarily mute uplink slots or symbols in order to limit or eliminate the uplink interference, state 246. In a muted state, the muted device will suppress radio transmission during designated symbols or slots, according to commands from the AI/ML model. The muting condition prevents a clash of transmissions and the ensuing inability of a receiver to reliably receive an intended transmission during the designated symbol or slot. When the muting period is ended, the UE or other radio may begin transmitting again. Information about the selected TDD slot ratio and the selected symbol ratio may be communicated to network equipment and the UE in any suitable manner.

In an eighth condition, the AI/ML model may detect that the UE is experiencing heavy downlink interference, step 248a. Interference may be detected in any suitable manner, such as an increase in SNR or BLER reported by the UE or other network radio. Accordingly, the AI/ML model will instruct the UE or other network equipment to temporarily mute downlink slots or symbols in order to limit or eliminate the uplink interference, state 248. When the muting is ended, the UE or other radio may begin transmitting again. Information about the selected TDD slot ratio and the selected symbol ratio may be communicated to network equipment and the UE in any suitable manner.

FIG. 2D depicts an illustrative embodiment of a method 250 in accordance with various aspects described herein. The method 250 illustrates an embodiment of operation of an artificial intelligence module or machine learning model (collectively, AI/ML model) to control fully dynamic TDD operation in a radio access network such as a 5G NR network. The steps of method 250 may be performed by any suitable network element. In an exemplary embodiment, a RIC such as RIC 218 of FIG. 2A may initiate and perform the method 250. Further, the method may be initiated or performed when a UE begins a data session with a mobile radio network, such as by registering with the network or requesting data or access to an application or initiating an application.

At step 252, when the data session is set up, the initial status starts with a balanced TDD pattern with a one downlink to one uplink ratio and no special slot assignments. Any other initial condition may be selected if conditions in the network warrant. As traffic starts, the model can operate under the following general rules.

At step 253, the method 250 includes retrieving information about the current uplink buffer and the current downlink buffer. Information to be transmitted over the radio link to or from the UE is stored in a buffer. Step 253 may include determining how much data or other information is contained in each buffer. Further, the data may have a priority, such as data associated with a relatively high quality of service (QoS). An example is data associated with a first responder such as police or fire personnel, who are generally given a relatively high priority in the network.

At step 254, the method 250 includes determining if the amount of data in the uplink buffer or the downlink buffer has changed. In an example, the amount of data or buffer size may be tracked over time and used to determine network response. Any suitable threshold values may be used to determine a response. For example, if one of the uplink buffer size and the downlink buffer size exceeds the other by a threshold amount, such as 10 MB, the method may determine to respond. Further, if the rate of change of one buffer size exceeds the other buffer size by a threshold amount, the method 250 may determine at step 254 that the buffer has changed.

If so, control proceeds to step 255 where the method 250 includes adjusting the ratio of the uplink buffer time slots or symbols to the downlink slots or symbols to accommodate the change. When the buffer sizes equilibrate to within a threshold or within an acceptable degree, the DL/UL ratio may be adjusted again. If at step 254, the uplink buffer or the downlink buffer size is not determined to be changing, control proceeds to step 256.

At step 256, the method 250 determines if the UE or other network element seeks to use the URLLC service of 5G. This may be done, for example, in the case of vehicle to vehicle (V2X) communications. If the service is sought to be used, at step 258, the method 250 includes adjusting the number of special slots or flexible symbols dedicated to the uplink or downlink with the UE. Any suitable number of special slots or flexible symbols may be designated for low latency services. If such low latency services are not desired at step 256, control proceeds to step 259.

At step 259, it is determined if radio interference on either the uplink or the downlink exceeds a predetermined threshold. Any suitable interference threshold may be used including a threshold in block error rate (BLER), threshold in signal to noise ratio (SNR) or any other suitable value. If such interference is detected, at step 260, the method 250 includes muting selected uplink or downlink slots. For example, if a UE in an adjacent cell reports excessive interference during particular slots, the method 250 may include muting an RRH from transmitting during the particular slots to reduce interference during a preselected muting time period. Similarly, if the base station or RRH reports an unusually high error rate exceeding a threshold, the method 250 may include muting a UE from transmitting during particular time slots in order to reduce interference generated by that UE. The muting time period may be of any suitable duration.

Control then proceeds to step 261. At step 261, the method 250 includes determining the type of radio access network currently involved. Step 262 operates to adjust the amount of delay in uplink and downlink transmissions in response to delay in signaling within the RAN If the RAN is a D-RAN, step 262 includes selecting a TDD configuration and symbol format featuring more uplink/downlink switches and fewer guard symbols. In other examples, the RAN may be a C-RAN, V-RAN or O-RAN or other network with increased delay between a baseband unit and a remote radio head. In such a case, at step 263, the method 250 includes selecting a TDD configuration and symbol format featuring fewer uplink/downlink switches and more guard symbols. In embodiments,

In embodiments, step 254, step 256, step 259 and step 261 are not mutually exclusive. These steps may operate at the same time within the AI/ML model to achieve an optimized or compromised outcome.

Control then returns to step 253 to again collect information about the uplink and downlink buffer sizes. Any other suitable steps may be performed as well. As network traffic levels and UE activity changes, the method 250 may automatically adjust the selected TDD configuration and symbol format to improve efficiency in the network. The method 250 enables the AI/ML model to identify the best combination of TDD pattern and slot format in real time and change it in the network dynamically to handle the changes in application behavior and radio condition.

FIG. 2E depicts an illustrative embodiment of an artificial intelligence or machine learning method 264 in accordance with various aspects described herein. The method of 264 may be performed at any suitable network component, such as the RIC 218 of FIG. 2A. The method 264 may be performed in conjunction with a database of information such as database 265. As illustrated in the example, database 265 stores information about, for example, URLCC applications, traffic levels on both uplink and downlink connections (as reflected in uplink and downlink buffer sizes, for example), and applications such as streaming video applications, vehicle to anything communications, cloud gaming, telemedicine and remote manufacturing. Any suitable information about network activity or application requirements may be stored and retrieved from the database 265.

At step 266, the method 264 includes an initial setup for a UE and network connection. This may be done at the beginning of a data session involving a UE. The initial setup may include any suitable configuration. In the example, when the method 264 initially has no information about activity in the network or active applications at the UE, the method 264 may select a balanced, one-to-one downlink-to-uplink ratio for the connection with the EU. The method 264 further includes an input step 267, a radio measurement step 268, a dynamic adjustment step 269 and a finalize configuration step 270.

In the input step 267 and the radio measurement step 268, three major principles or inputs are available for adjustment of the TDD configuration or slot format. The input step 267 includes a buffer-based adjustment, step 271, a latency-based adjustment, step 272, and an interference based adjustment, step 273. First, any adjustment to the TDD configuration or slot format may be buffer based. That is, the method 264 determines at step 271 from contents and sizes of the uplink buffer or the downlink buffer if the UL to DL ratio should be adjusted. If buffer usage is moving out of balance, the ratio of uplink to downlink time slots or symbols should be adjusted. At step 274, the UL/DL ratio may be adjusted by any suitable amount, such as from a 1:1 ratio to a 2:1 ratio, 4:1 ratio, 8:1 ratio, etc. The method 264 operates to change the DL/UL slot ratio according to UL/DL buffer ratio.

Second, any adjustments to the TDD configuration or slot format may be latency based. Generally, latency adjustments are intended to affect a particular service such as URLLC or an application that uses such services such as V2X. The method 264 may respond to input information received from, for example, the database 265 by increasing or decreasing the number of special slots dedicated to uplink or downlink communications, step 275a. Further, the method 264 may respond to the input information by changing the slot format, such as by reassigning flexible symbols. The method 264 operates to change the number of special slots and/or special slot format to meet application latency requirements.

Third, any adjustments to the TDD configuration or slot format may be interference based, step 273, based on the radio measurement step 268. For example, the method 264 may retrieve current interference information reported by UE devices operating in the network as well as reported by network equipment such as RRH devices. Based on the interference information, the method 264 may selectively mute uplink or downlink slots, step 276, to reduce or eliminate the interference in the network. The method 264 operates to mute the slots when interference is detected with poor SINR or high BLER, for example.

In the dynamic adjustment step 269, the method 264 operates to adjust the TDD pattern and/or the slot format to handle different RAN deployments. The dynamic adjustment step 269 includes a process of applying results of the input step 267 and the radio measurement step 268 to different types of radio access network. Thus, any special requirements for each type of network, the D-RAN, the C-RAN, etc., may be further applied by the method 264 to the selections previously made by the method 264. In particular, as noted, for a distributed radio access network (D-RAN), relatively more uplink/downlink switches may be factored into the selection of a TDD configuration and a slot format along with a reduced delay time since the BBU and the RRH are located relatively proximate. Separately, for a cloud radio access network (C-RAN), the TDD configuration and slot format should be chosen with fewer uplink/downlink switches and some built-in delay to accommodate the delay between remote network components.

Based on the operation of the dynamic adjustment step 269, the slot format and TDD configuration may be finalized at step 270. The result to the end user at the UE should be a measurable improvement in terms of throughput and delay. Throughput refers to the rate of data processing or transfer between the UE and the network. Delay may refer to latency including the one-way or round-trip time between a data source and a data destination. Other key performance indicators should be improved as well.

In some embodiments, a feedback process is included at step 277. For example, the method 264 may repeat some or all of step 271, step 272, step 273, step 274, step 275a, step 275b and step 276 above based on measurements every 20 ms until the end user receives better quality of experience (QoE). Any suitable time period for repetition, other than 20 ms, may be used. Any suitable QoE measurement or standard may be used as well. Further, in step 278, when a new application is used or becomes accessible, requirements are updated in the database 265 and wherever else necessary to find the most appropriate TDD pattern and slot format combination for the application. Finally, to complete the adaptation process for the AI/ML model, step 279 includes a process of building and updating the database 265 to match different applications with different TDD patterns and slot formats for initial setup, step 266, for future uses. At step 280, the selected TDD configuration and slot format are used to establish or modify the channel with the UE.

In some embodiments, the database 265 or other network element may store information such as profiles that contain preselected information for a particular network environment or situation or a particular UE or user associated with the UE. The profiles may include input conditions that enable selection or preselection of one or more candidate TDD configurations and slot formats. For example, if the UE is using or accessing a URLLC service, based on that input, the method 264 may select a profile for URLLC configurations. The profile may include candidate configurations that, rather than a balanced one-to-one uplink-to-uplink ratio, instead use four-to-one or eight-to-one ratio to improve performance by reducing latency. By selecting one of the candidates based on the knowledge or information about the current particular network environment or situation, rather than the balanced initial point, the AI/ML model will adapt more rapidly to a better or best solution for the current situation. For example, the AI/ML model may use the one or more candidate TDD configurations to facilitate convergence to a solution that provides the currently best TDD configuration for the UE. Reduced iterations of the feedback loop will be needed to find an acceptable solution by the AI/ML model.

Any suitable model or combination of models may be used. For a relatively simple analysis, a machine learning regression model may be used in predictive analysis to forecast trends and predict outcomes. The regression mode may be trained on any suitable training data to understand the relationship between different independent variables and an outcome. For more complicated modeling, including situations with more inputs, one or more neural network models may be used, alone or in combination with other models.

As noted, the initial setup, step 266, may be tailored to the particular UE. When the UE registers with the network, followed by a packet data unit (PDU) session establishment, the AI/ML model may make selections or estimations based on the initial PDU session. The PDU session corresponds to a logical connection between the UE and a data network such as the public internet and a private network. The PDU session is used to carry user data and can support different types of services, such as voice, video, and data. The UE initiates the PDU session establishment process by sending a request to the 5G core network. The request includes information about the type of service that the UE wants to use, and the type of traffic. Based on this information, the AI/ML model may determine what services or applications the UE may require and select an initial TDD configuration and slot format, or a set of suitable TDD configurations and slot formats, for the UE. As the session with the UE proceeds, the AI/ML model may converge on a better solution, based on the initial estimate or initial selection of TDD configurations and slot formats.

While for purposes of simplicity of explanation, the respective processes are shown and described as a series of blocks in FIG. 2D and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

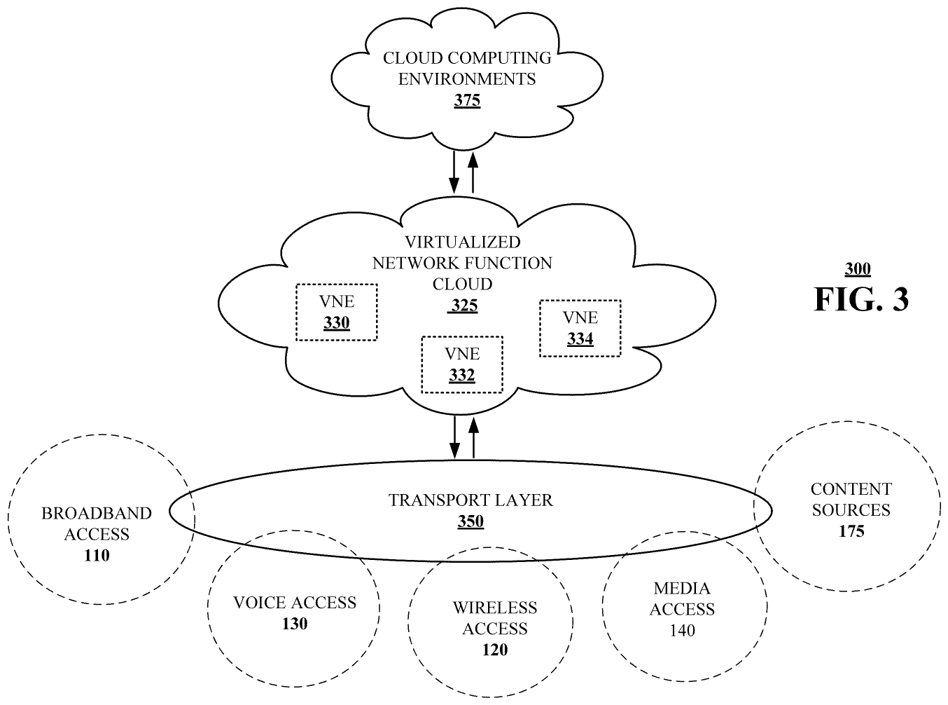

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of radio communication network 200, method 250, and method 264 presented in FIG. 1, FIG. 2A, FIG. 2B, FIG. 2C, FIG. 2D, FIG. 2E and FIG. 3. For example, virtualized communication network 300 can facilitate in whole or in part selecting an initial time division duplex (TDD) configuration for a user device such as a UE in a radio network and dynamically modifying the TDD configuration for the UE based on conditions for the UE and using an artificial intelligence model or machine learning model.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

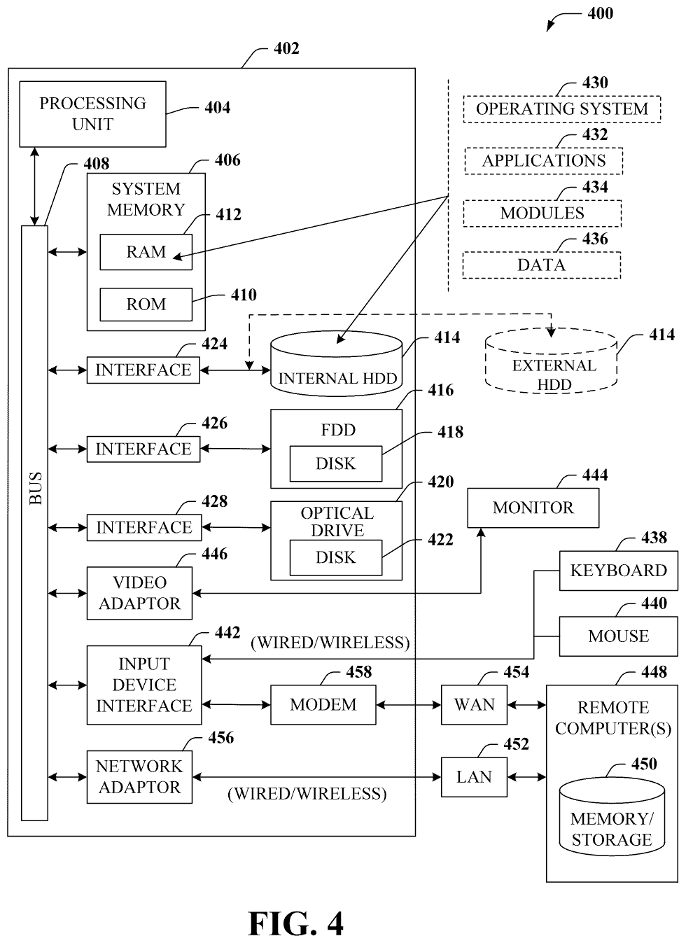

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part selecting an initial time division duplex (TDD) configuration for a user device in a radio network and dynamically modifying the TDD configuration based on conditions for the user device and using an artificial intelligence model or machine learning model. For example, the artificial intelligence model or machine learning model, or a combination of these, may be implemented using the computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

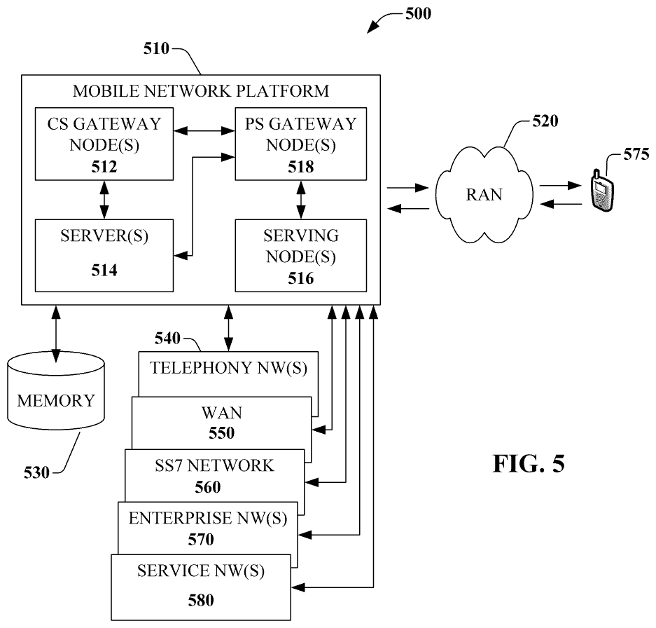

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part selecting an initial time division duplex (TDD) configuration for a user device such as radiotelephone 575 in a radio network such as RAN 520 and dynamically modifying the TDD configuration based on conditions for the user device and using an artificial intelligence model or machine learning model. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

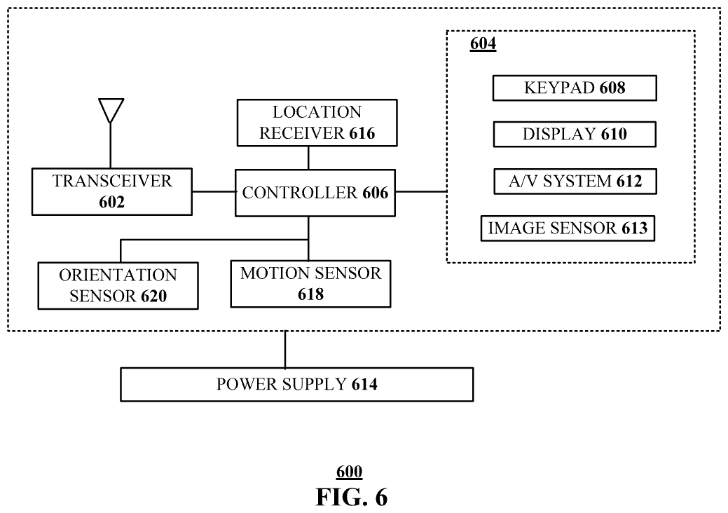

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part selecting an initial time division duplex (TDD) configuration for a user device such as the communication device 600 in a radio network such as a RAN and dynamically modifying the TDD configuration based on conditions for the user device using an artificial intelligence model or machine learning model.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a registration from a user equipment (UE) accessing a radio communication network;
selecting an initial time division duplex (TDD) configuration for the UE;
communicating information about the initial TDD configuration to the UE;
communicating with the UE according to the initial TDD configuration;
detecting, by an artificial intelligence/machine learning (AI/ML) model, a changed condition for the UE;
selecting, by the AI/ML model, a new TDD configuration for the UE, wherein the new TDD configuration is based on the changed condition for the UE; and
communicating the new TDD configuration to the UE for further communication with the radio communication network.

2. The device of claim 1, wherein the detecting a changed condition for the UE comprises:
detecting an uplink buffer size and a downlink buffer size associated with the UE; and
identifying a changed condition for the UE based on a change to the uplink buffer size, a change to the downlink buffer size, or both.

3. The device of claim 2, wherein the selecting a new TDD configuration for the UE comprises:
adjusting a ratio of downlink time slots to uplink time slots or a ratio of downlink slot format to uplink slot format, or both, wherein the adjust is responsive to the changed condition for the UE.

4. The device of claim 1, wherein the operations further comprise:
detecting a latency-sensitive service requested by the UE; and
selecting the new TDD configuration for the UE based on the latency-sensitive service requested by the UE.

5. The device of claim 4, wherein the detecting a latency-sensitive service requested by the UE comprises:
detecting a request to access an Ultra-Reliable Low Latency Communication (URLCC) service.

6. The device of claim 5, wherein the selecting the new TDD configuration for the UE based on the latency-sensitive service requested by the UE comprises:
selecting, as the new TDD configuration, a TDD configuration having a greater number of special slots than a number of special slots in the initial TDD configuration, the special slots designated as either uplink slots or downlink slots according to the request to access the URLCC service.

7. The device of claim 1, wherein the detecting a changed condition for the UE comprises:
identifying an interference condition on an uplink or a downlink associated with the UE; and
muting communication on one of the uplink or the downlink associated with the UE to limit the interference condition.

8. The device of claim 1, wherein the selecting an initial TDD configuration for the UE comprises:
detecting a type of radio access network (RAN) of the radio communication network, wherein a first type of RAN has a remote radio head (RRH) proximate a baseband unit (BBU) and a second type of RAN has a remote radio head (RRH) distal a baseband unit (BBU) such that the second type of RAN includes an increased delay time relative to the first type of RAN; and
responsive to the first type of RAN, selecting as the initial TDD configuration for the UE a TDD configuration having relatively fewer uplink-downlink switches and relatively fewer guard symbols; and
responsive to the second type of RAN, selecting as the initial TDD configuration for the UE a TDD configuration having relatively more uplink-downlink switches and relatively more guard symbols to accommodate the increased delay time.

9. The device of claim 1, wherein the operations further comprise:
identifying an initial operating condition of the UE; and
preselecting one or more candidate TDD configurations for the UE based on the initial operating condition of the UE.

10. The device of claim 9, wherein the operations further comprise:
receiving a packet data unit (PDU) establishment communication from the UE;
determining, based on the PDU establishment communication, a service to be accessed by the UE; and
selecting the initial TDD configuration for the UE based on the service to be accessed by the UE.

11. A non-transitory machine-readable medium, comprising executable instructions that, when executed by a processing system including a processor, facilitate performance of operations, the operations comprising:
selecting a time division duplex (TDD) configuration for a user equipment (UE) in a radio access network;
providing information about the TDD configuration to the UE;
communicating with the UE according to the TDD configuration;
selecting, by an artificial intelligence/machine learning (AI/ML) model, a new TDD configuration for the UE, wherein the AI/ML model selects the new TDD configuration based on a changed condition for the UE in the radio access network, the new TDD configuration to provide improved throughput or reduced delay for the UE, or both; and
providing, to the UE, information about the new TDD configuration.

12. The non-transitory machine-readable medium of claim 11, wherein the operations further comprise identifying an input condition, wherein the identifying an input condition comprises:
identifying a buffer-based communication limitation for the UE, wherein the buffer-based communication is based on a status of an uplink buffer, a downlink buffer, or both;
identifying a latency-based communication limitation for the UE, wherein the latency-based communication limitation is based on a selected service or a selected application of the UE;
identifying an interference-based communication limitation for the UE, wherein the interference-based communication limitation is based on radio interference on an uplink or a downlink associated with the UE; and
selecting, by the AI/ML model, the TDD configuration based on the input condition.

13. The non-transitory machine-readable medium of claim 12, wherein the operations further comprise:
selecting, based on the input condition, one or more candidate TDD configurations for the UE; and
selecting, by the AI/ML model, the TDD configuration based on the one or more candidate TDD configurations, wherein the one or more candidate TDD configurations facilitate convergence by the AI/ML model to a solution for the TDD configuration.

14. The non-transitory machine-readable medium of claim 11, wherein the selecting a new TDD configuration for the UE comprises:
selecting a TDD slot configuration; and
selecting a symbol format for the UE.

15. The non-transitory machine-readable medium of claim 11, wherein the selecting a TDD slot configuration comprises:
selecting a ratio of downlink timeslots to uplink timeslots for the UE.

16. A method, comprising:
assigning, by a processing system including a processor, an initial time division duplex (TDD) configuration to a user equipment (UE) for communication with a radio access network (RAN);
communicating, by the processing system, with the UE according to the initial TDD configuration;
detecting, by the processing system, a change in the communicating with the UE;
assigning, by the processing system, a new TDD configuration to the UE, wherein the assigning comprises selecting the new TDD configuration based on changes in communication patterns of the UE with the radio access network, the new TDD configuration selected to improve data throughput between the UE and the radio access network; and
communicating, by the processing system, with the UE according to the new TDD configuration.

17. The method of claim 16, wherein the assigning a new TDD configuration to the UE comprises:
selecting, by the processing system, a ratio of downlink time slots to uplink time slots based on changes in communication patterns of the UE with the radio access network.

18. The method of claim 17, comprising:
receiving, by the processing system, information about a buffer size for an uplink and a buffer size for a downlink; and
selecting, by the processing system, the ratio of downlink time slots to uplink time slots to balance the buffer size for the uplink and the buffer size for the downlink.

19. The method of claim 16, comprising:
receiving, by the processing system, a request from the UE to use a low-latency service of the radio access network; and
assigning, by the processing system, more special time slots to the UE to provide the low-latency service to the UE.

20. The method of claim 16, comprising:
receiving, by the processing system, information about interference on one of a downlink and an uplink; and
muting, by the processing system, transmission on one or more selected downlinks or one or more uplinks to limit the interference.
